(19) United States
(12) Patent Application Publication
(10) Pub. No.: US 2026/0346346 A1
(43) Pub. Date: Nov. 5, 2026

(54) TUBE DRILL

(71) Applicant: Gühring KG, Albstadt (DE)

(72) Inventors: Markus LOHR, Albstadt (DE); Ingo VON PUTTKAMER, Albstadt (DE); Thomas BISCHOFF, Immenstaad (DE)

(73) Assignee: Gühring KG, Albstadt (DE)

(21) Appl. No.: 19/454,345

(22) Filed: Jan. 20, 2026

(30) Foreign Application Priority Data
Jan. 21, 2025 (DE) 10 2025 102 017.5

(51) Int. Cl. B23B 51/06

(52) U.S. Cl. CPC B23B 51/063; B23B 2251/244; B23B 2251/408

(57) ABSTRACT

A drilling tool, in particular deep hole drilling tool, with a shank, a single- or multi-edged drill head, an outer pipe connecting the shank to the drill head for removing chips created during a drilling of a workpiece in the direction of the shank and an inner pipe extending from the shank to the drill head in the outer pipe for feeding cooling lubricant to the drill head. The outer circumferential surface of the inner pipe arranged centrally within the outer pipe delimits an annular chip removal space with the inner circumferential surface of the outer pipe.

The invention relates to a drilling tool, in particular a deep hole drilling tool, with an inner coolant supply and an inner chip removal.

A drilling tool of this type is known from the DE 2034664 A. The proposed drilling tool has a shank and an at least single-edged drill head. The drill head is connected to the shank via an outer pipe. An inner pipe is fitted into the outer pipe. The inner pipe rests over its entire length against the inner circumferential surface of the outer pipe and thus reinforces the outer pipe.

In one embodiment, the inner pipe forms two flow channels, which are semi-circular in cross section and which are separated from one another by means of a separating wall. One of the flow channels, which is characterized by a smaller flow cross section than the other flow channel, has the function of feeding a cooling lubricant to a tool cutting edge on the drill head, while the other flow channel has the function of removing chips created during a drilling of a workpiece in the direction of the shank supported by cooling lubricant. The flow channels separated from one another by means of the separating wall, which has a rounded cross section, thus run parallel to one another and, viewed radially, in each case eccentrically along the inner circumferential surface of the outer pipe. The flow channel, which serves the purpose of carrying away the chips, continues towards the shank in a further channel, which is arranged in the shank and which leads laterally outwards. In another embodiment, the inner pipe has, in the main portion of its circumference, an essentially cylindrical outer shape and, in the remaining portion of its circumference, a recess, which is directed radially inwards and which extends along the inner pipe and forms a groove, which is straight in the axial direction and which, with the inner circumferential surface of the outer pipe, forms the flow channel, which guides a cooling lubricant in the direction of the drill head. It applies for each of the embodiments that a cooling lubricant, which is guided via the flow channel, which has a smaller cross section, into a through channel in the drill head and which escapes into a drill hole in the region of a tool flank, flows back in the direction of the shank via the at least one tool cutting edge on the drill head into the flow channel, which has a larger cross section, and thereby entrains the chips created at the at least one tool cutting edge during a drilling of a workpiece.

Based on the DE 2034664 A, the invention has the object of creating a drilling tool, which can be produced easily and which is characterized by a high compressive, torsional and bending strength as well as a high concentricity, in particular with regard to deep hole bore.

This object is solved by means of a drilling tool with the features of claim 1. Advantageous further developments are subject matter of dependent claims.

A drilling tool according to the invention, in particular deep hole drilling tool, has a shank, a single-or multi-edged drill head, an outer pipe connecting the shank to the drill head and an inner pipe extending from the shank to the drill head in the outer pipe.

The shank has the function of holding the drilling tool in a tool holder, for example a clamping chuck. For this purpose, the shank can have, for example, a threaded section, which is to be screw-connected to a tool holder. Alternatively, the shank can be formed cylindrically or conically, for example for clamping into a clamping chuck.

The drill head has one or several tool cutting edges. The at least one tool cutting edge can be formed directly on the drill head or on a cutting plate carried by the drill head. The drill head can thus be embodied monolithically or can be modularly composed of a drill head body and at least one cutting plate fastened to the drill head body. The drill head preferably has an assigned chip flute for each tool cutting edge. The chip flute can run in a straight line or helically. The drill head can furthermore have an internal cooling lubricant distribution system, which leads from an entry opening connecting to the inner pipe to an exit opening assigned to the at least one tool cutting edge. Viewed in the direction of rotation or cutting direction of the tool, respectively, the exit opening assigned to the tool cutting edge can lie downstream from the tool cutting edge, for example in the region of a tool flank adjoining the tool cutting edge.

The outer pipe connects the drill head to the shank in an axial manner and so as to transmit torque. For this purpose, the outer pipe can be connected to the shank and the drill head in a positive manner and/or by means of a substance-to-substance bond, preferably by means of soldering. The inner pipe arranged centrally in the outer pipe extends, preferably in a straight line, from the shank to the drill head in the outer pipe. While the inner pipe has the function of guiding cooling lubricant to the drill head, the outer pipe has the function of removing chips on the drill head created during a drilling of a workpiece on the at least one tool cutting edge in the direction of the shank via the annular space between the inner circumferential surface of the outer pipe and the outer circumferential surface of the inner pipe. The outer pipe thus acts as a shield, which prevents a chip exit from the drilling tool into the surround area, at least up to a chip exit opening, which will be explained later on. In terms of a chip removal cross section, which is as consistent as possible, the inner pipe is preferably arranged coaxially and concentrically to the outer pipe in the latter.

The outer pipe and the inner pipe are preferably made from steel pipes with circular-cylindrical cross section.

The positive connection and/or substance-to-substance bond of the drill head and of the shank with the outer pipe and the inner pipe provides for a reliable stiff connection, which ensures the compressive, torsional and bending strength required for a drilling, in particular a deep hole drilling. Due to the central arrangement of the inner pipe in the outer pipe, mass imbalances can be kept low, whereby a high concentricity is achieved. In addition, the drilling tool can be produced easily because owing to the use of circular-cylindrical pipes, no complex shaping of the inner pipe is required.

For drilling into solid material, the drill head can be formed in a front-cutting and circumferentially-cutting manner, i.e., can have at least one main cutting edge lying on the front side and at least one secondary cutting edge cutting circumferentially.

For removal of the chips creating on the drill head during a drilling of a workpiece, the drill head can have at least one, preferably helically running chip flute, which continues in the direction of the shank in the outer pipe. In terms of an optimal transfer of the chips from the at least one cutting edge, the outer pipe can have, on its drill head-side end section, an axial appendage for each chip flute, which extends into the chip flute and closes the at least one chip flute radially outwards in the extension region of the axial appendage.

To connect the drill head to the outer pipe, a diameter-reduced shank-side end section of the drill head can be received in a flush manner in a drill head-side end section of the outer pipe.

A diameter-reduced drill head-side end section of the shank can likewise be received in a flush manner in a shank-side end section of the outer pipe.

In an end section adjoining the drill head-side end section of the shank, the outer pipe can furthermore have at least one chip ejection opening.

In order to avoid dull impact surfaces, the diameter-reduced drill head-side end section of the shank can have, towards the drill head, a, for example, wedge-shaped or conical protrusion, which extends axially into the region of the at least one chip ejection opening. The protrusion has the function of redirecting chips transported in the direction of the shank outwards towards the at least one chip ejection opening.

A preferred embodiment of a drilling tool composed of a shank, a drill head, an inner pipe and an outer pipe, will be explained below with the help of the drawings, in which:

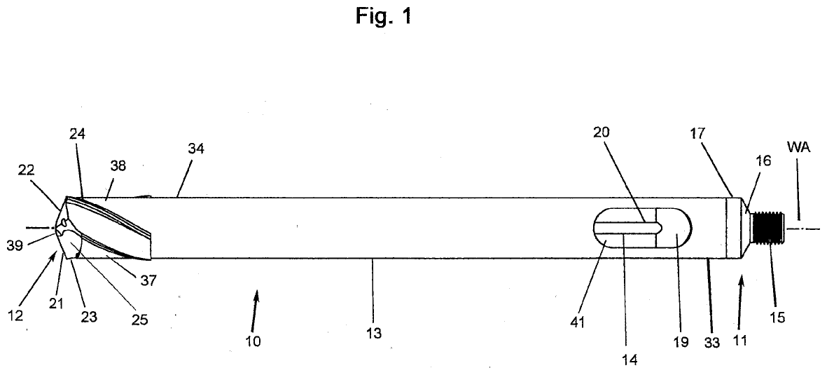

FIG. 1 shows a side view of a drilling tool;

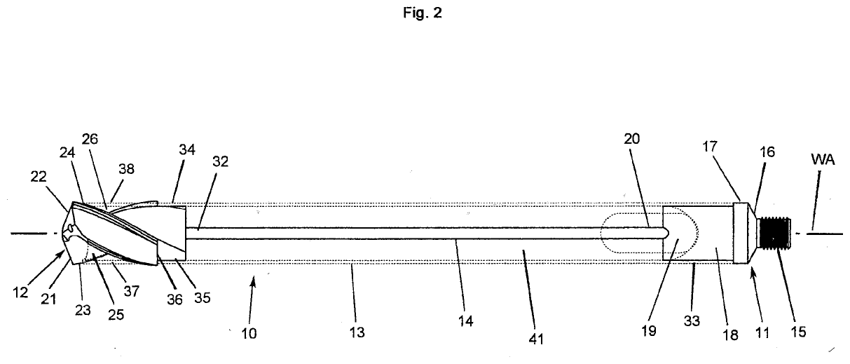

FIG. 2 shows a side view of the drilling tool from FIG. 1, wherein an outer pipe is illustrated in a transparent manner;

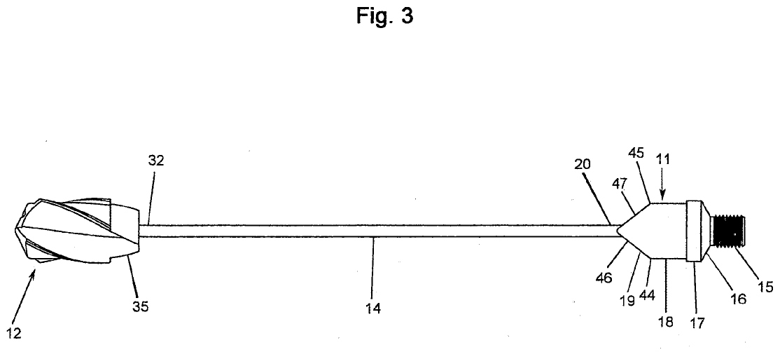

FIG. 3 shows a side view of the drilling tool, in which the outer pipe is missing;

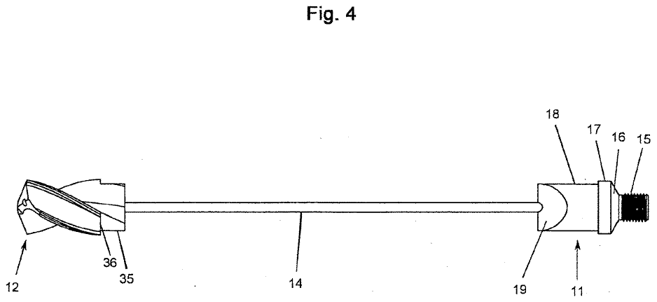

FIG. 4 shows a side view, which, compared to FIG. 3, is rotated about the tool axis;

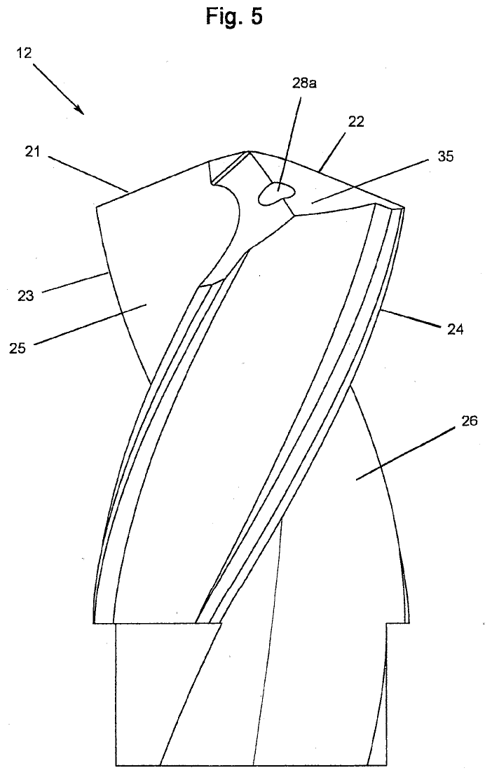

FIG. 5 shows a side view of a drill head;

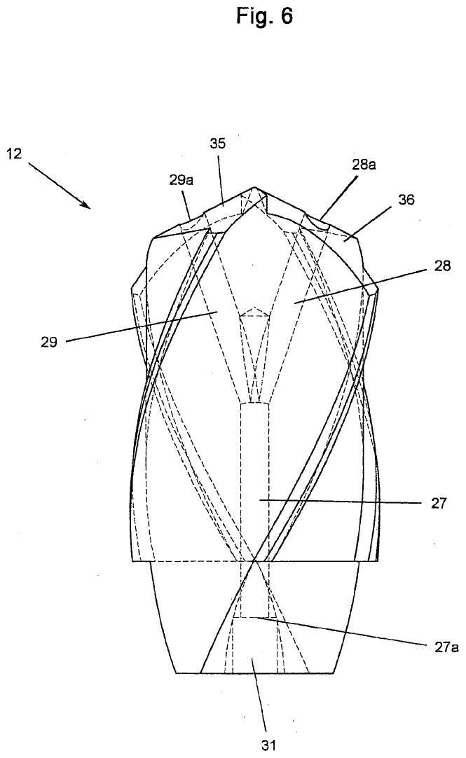

FIG. 6 shows a side view, which, compared to FIG. 5, is rotated and in which a cooling lubricant distribution system is illustrated in a dashed manner;

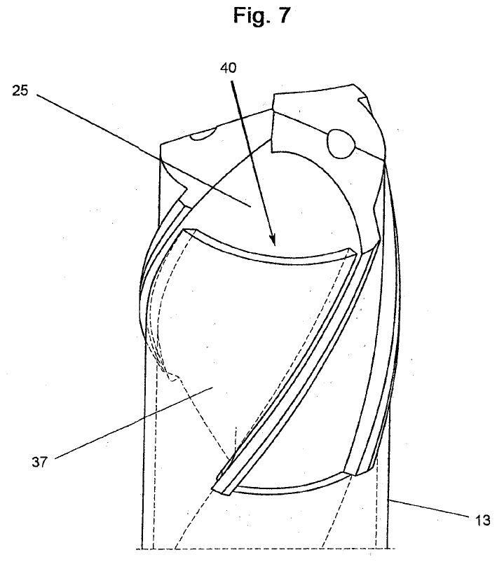

FIG. 7 shows a perspective view of the connecting point of the drill head to the outer pipe, which is illustrated in a transparent manner for understanding the connecting point; and

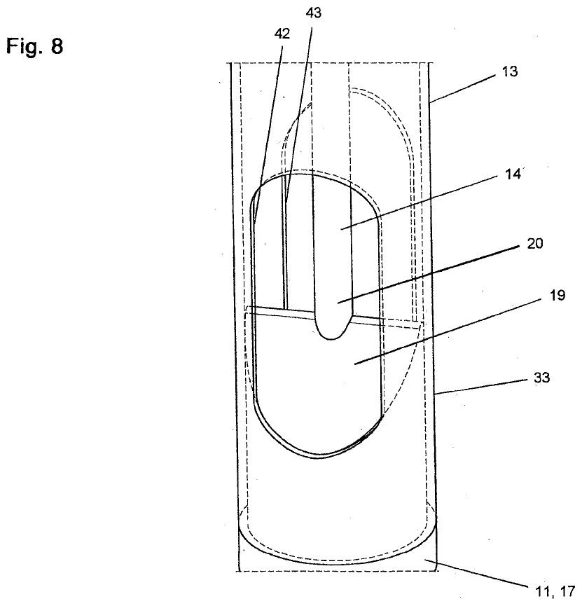

FIG. 8 shows a perspective view of the connecting point of a shank to the outer pipe, which is illustrated in a transparent manner for understanding the connecting point.

### PREFERRED EMBODIMENT

FIG. 1 and FIG. 2 show a drilling tool 10 extending along a tool axis WA with a shank 11, a double-edged drill head 12, an outer pipe 13 connecting the shank 11 to the drill head 12 and an inner pipe 14 extending from the shank 11 to the drill head 12 in the outer pipe 13.

The shank 11, which is preferably made of a tool steel, has the function of holding the drilling tool 10 in a (non-illustrated) tool holder. In the shown embodiment, the shank 11 has, for this purpose, on its end section on the right in FIG. 1 and FIG. 2, a threaded section 15, which is to be screw-connected to the (non-illustrated) tool holder. A collar 17, which forms an axial stop for the outer pipe 13, adjoins the threaded section 15 towards the drill head 12 via a frustoconical transition section 16. A connecting section 18 of the shank 13, which is reduced in diameter compared to the collar 17, has, on its end on the left in FIG. 1 and FIG. 2, a wedge-shaped taper 19, which can be seen in FIG. 3. A receiving opening—not illustrated in more detail—in which a shank-side end section 20 of the inner pipe 14 is received in a positive manner and is soldered to the shank 11 in terms of a connection, which is fixed and cooling lubricant-tight in the direction of rotation and axial direction, is formed on the tip of the wedge-shaped taper 19, which points towards the drill head 12.

In the shown embodiment, the drill head 12, which is preferably ground from a hard metal body, as shown in FIG. 5, has two front-side main cutting edges 21, 22, which are adjoined by two circumferentially cutting secondary cutting edges 23, 24 in the direction of the shank 11, for drilling into solid material. The cutting edges 21 to 24 are ground directly into the drill head 12. The drill head 12 additionally has two helically running chip flutes 25, 26. The drill head 12 is thus embodied monolithically.

FIG. 6 furthermore reveals a cooling lubricant distribution system, which is formed in the drill head 12 and which has a central main channel 27 and branch channels 28, 29 branching off from the main channel 27. An entry opening 27a of the main channel 27 adjoins an axial receiving opening 31, which is centrally formed in the drill head 12 and in which a drill head-side end section 32 of the inner pipe 14 is received in a positive manner. In terms of a connection, which is fixed and cooling lubricant-tight in the direction of rotation and axial direction, the end section 32 of the inner pipe 14 is soldered to the drill head 12 in the region of the receiving opening 31. Exit openings 28a, 29a of the branch channels 28, 29 lie in the region of the tool flanks 35, 36 lying downstream from the main cutting edges 21, 22, viewed in the direction of rotation or cutting direction of the tool, respectively.

As does the inner pipe 14, the outer pipe 13, which is illustrated in a transparent manner in FIG. 2 and FIG. 7 and which concentrically surrounds the inner pipe 14, also connects the drill head 12 to the shank 11 in an axial manner and so as to transmit torque. For this purpose, the diameter-reduced connecting section 18 is received with the wedge-shape taper 19 in a positive manner in the shank-side end section 33 of the outer pipe 13 resting against the collar 17. In terms of a connection, which is fixed in the direction of rotation and axial direction, the shank-side end section 33 of the outer pipe 13 is soldered to the shank 11. On its drill head-side end section 34, the outer pipe 13 receives a diameter-reduced end section 35 of the drill head 12 in a positive manner. As shown in FIG. 2, the outer pipe 13 rests against the end of the diameter-reduced end section 35 of the drill head 12 on a step 36. In terms of a connection, which is fixed in the direction of rotation and axial direction, the drill head-side end section 34 of the outer pipe 13 is soldered to the drill head 12 by means of a substance-to-substance bond.

The inner pipe 14 and the outer pipe 13 are preferably each made from steel pipes with circular-cylindrical cross section.

FIG. 2 and FIG. 7 show that the outer diameter of the outer pipe 13 has a smaller diameter than the nominal diameter of the drilling tool 10.

FIG. 1, FIG. 2 and FIG. 7 furthermore show that finger-like appendages 37, 38, which, starting at the drill head-side end section 34 of the outer pipe 13, protrude in the direction of the tool tip 39, engage with the chip flutes 25, 26 until just upstream of the cutting edge corners. FIG. 1 and FIG. 7 show the helical extension of the finger-like appendages 37, 38, which corresponds to the course of the chip flutes 25, 26. Viewed in the circumferential direction, the finger-like appendages 37, 38 rest flush against the wall forming the respective chip flute 25, 26 in the drill head 12 across their length, so that the chip flutes 25, 26 are closed radially outwards in the extension region of the axial appendages 37, 38, whereby chip removal channels, which are shielded outwards are created. FIG. 7 shows the entry opening 40 of one of the chip removal channels, which is in each case shielded outwards by means of a finger-like appendage 37, 38, and which, as revealed in FIG. 1, lead into the annular chip removal space 41, which is delimited by the inner pipe 14 and the outer pipe 13.

FIG. 1 and FIG. 8 show chip ejection openings 42, 43 formed in the shank-side end section 33 of the outer pipe 13. The wedge-shaped protrusion 19 on the drill head-side end of the connecting section 18 of the shank 11 extends axially into the region between the diametrically opposite chip ejection openings 42, 43. Towards the shank 11, the chip ejection openings 42, 43 end on the edges 44, 45 of the side surfaces 46, 47 of the wedge-shaped tapered protrusion 19, which taper off towards the shank 11.

1. A drilling tool, comprising a shank, a single- or multi-edged drill head, an outer pipe connecting the shank to the drill head for removing chips created during a drilling of a workpiece in the direction of the shank and an inner pipe extending from the shank to the drill head in the outer pipe for feeding cooling lubricant to the drill head, wherein:
an outer circumferential surface of the inner pipe arranged centrally within the outer pipe delimits an annular chip removal space with an inner circumferential surface of the outer pipe.

2. The drilling tool according to claim 1, wherein a cooling lubricant distribution system is formed in the drill head with an entry opening adjoining the inner pipe and front side exit openings.

3. The drilling tool according to claim 1, wherein for drilling into solid material, the drill head is formed in a front-cutting and circumferentially-cutting manner.

4. The drilling tool according to claim 3, wherein:
the drill head has at least one chip flute, and
on its drill head-side end section, the outer pipe extends into the at least one chip flute via an axial appendage and closes the at least one chip flute radially outwards in the extension region of the appendage.

5. The drilling tool according to claim 1, wherein a diameter-reduced shank-side end section of the drill head is received in a flush manner in a drill head-side end section of the outer pipe.

6. The drilling tool according to claim 1, wherein a diameter-reduced drill head-side connecting section of the shank is received in a flush manner in a shank-side end section of the outer pipe.

7. The drilling tool according to claim 6, wherein adjoining the connecting section of the shank, the outer pipe has at least one chip ejection opening.

8. The drilling tool according to claim 7, wherein towards the drill head, the connecting section of the shank has a protrusion, which is tapered in a wedge-shaped manner and which extends axially into a region of the at least one chip ejection opening.

9. The drilling tool according to claim 1, wherein the drill head consists of hard metal.

10. The drilling tool according to claim 1, characterized by a double-edged drill head with helically running chip flutes.

11. The drilling tool according to claim 1, wherein the outer pipe and the inner pipe are connected to the shank and the drill head in a positive manner and/or by means of a substance-to-substance bond.

12. The drilling tool according to claim 4, wherein the at least one chip flute is helically running.
